(19) United States
(12) Patent Application Publication
(10) Pub. No.: US 2017/0259420 A1
(43) Pub. Date: Sep. 14, 2017

(54) Replaceable hitting structure for hammer

(71) Applicant: Ting-Wei CHU, Taichung City (TW)

(72) Inventor: Ting-Wei CHU, Taichung City (TW)

(21) Appl. No.: 15/063,525

(22) Filed: Mar. 8, 2016

(51) Int. Cl. B25D 1/14; B25D 1/12

(52) U.S. Cl. CPC B25D 1/14; B25D 1/12

(57) ABSTRACT

A replaceable hitting structure for a hammer contains: a body, a handle extending downwardly from a middle portion of the body, and at least one hitting block connected with the body. The body includes an accommodation extension arranged on one end thereof, a housing groove defined in the accommodation extension, and a peripheral trench defined in the housing groove. Each hitting block includes a hammering face formed on a first side thereof, a connecting face arranged on a second side thereof, a coupling post extending outwardly from the connecting face and accommodated in the housing groove, a fixing notch defined on an outer wall of the coupling post, and a positioning ring retained in the fixing notch. When the coupling post is housed in the housing groove, the positioning ring contacts with the peripheral trench of the body, and the connecting face engages with the accommodation portion.

### FIELD OF THE INVENTION

The present invention relates to a replaceable hitting structure for a hammer which is capable of prolonging service life of the hammer

### BACKGROUND OF THE INVENTION

Referring to FIG. 1, a conventional replaceable hammer contains a body 40 and a hitting block 50, wherein the body 40 has a threaded orifice 41 defined in one end thereof, and the hitting block 50 has a screwing post 51 extending outwardly from one end thereof so as to screw with the threaded orifice 41 of the body 40, hence the hitting block 50 is replaceable according to using requirements.

However, as hitting object by using the hitting block, the hitting block removes from the body easily because of impact force and vibration, thus damaging the screwing post often.

The present invention has arisen to mitigate and/or obviate the afore-described disadvantages.

### SUMMARY OF THE INVENTION

The primary objective of the present invention is to provide a replaceable hitting structure for a hammer which is capable of prolonging service life of the hammer.

To obtain the above objective, a replaceable hitting structure for a hammer provided by the present invention contains: a body, a handle extending downwardly from a middle portion of the body, and at least one hitting block connected with the body.

The body includes an accommodation extension arranged on one end thereof, a housing groove defined in the accommodation extension, and a peripheral trench defined in the housing groove.

Each hitting block includes a hammering face formed on a first side thereof, a connecting face arranged on a second side thereof, a coupling post extending outwardly from the connecting face and accommodated in the housing groove, a fixing notch defined on an outer wall of the coupling post, and a positioning ring retained in the fixing notch.

When the coupling post is housed in the housing groove, the positioning ring contacts with the peripheral trench of the body, and the connecting face engages with the accommodation portion matingly.

### BRIEF DESCRIPTION OF THE DRAWINGS

FIG. 1 is a cross sectional view of a conventional replaceable hammer.

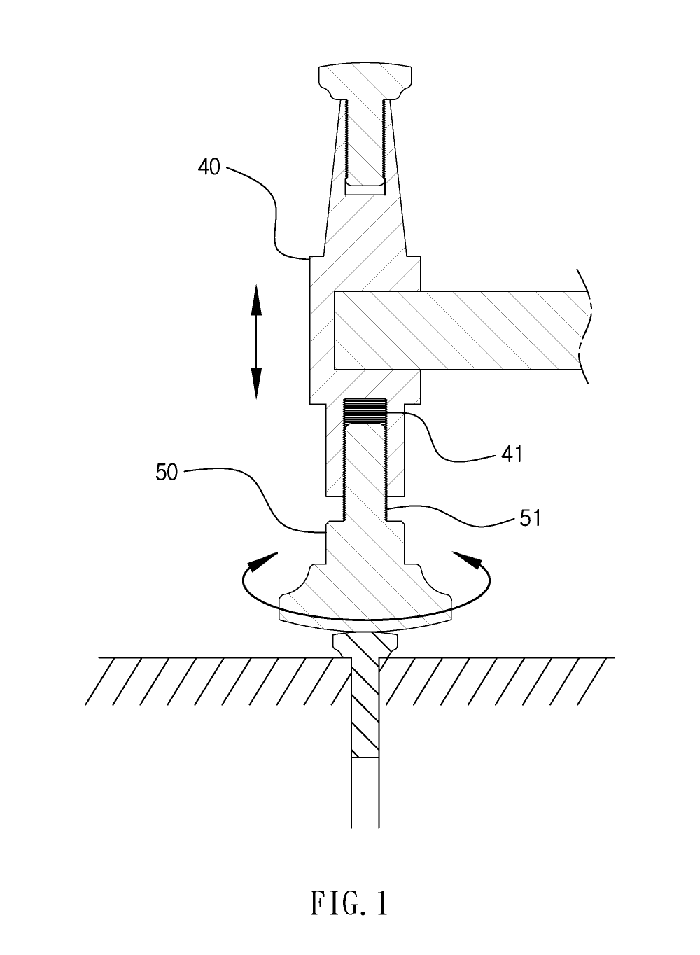

FIG. 2 is a cross-sectional perspective view showing the exploded components of a replaceable hitting structure for a hammer according to a preferred embodiment of the present invention.

FIG. 3 is a perspective view showing the assembly of the replaceable hitting structure for the hammer according to the preferred embodiment of the present invention.

FIG. 4 is a cross sectional view showing the assembly of the replaceable hitting structure for the hammer according to the preferred embodiment of the present invention.

FIG. 5 is a cross sectional view showing the operation of the replaceable hitting structure for the hammer according to the preferred embodiment of the present invention.

FIG. 6 is another cross sectional view showing the operation of the replaceable hitting structure for the hammer according to the preferred embodiment of the present invention.

### DETAILED DESCRIPTION OF THE PREFERRED EMBODIMENTS

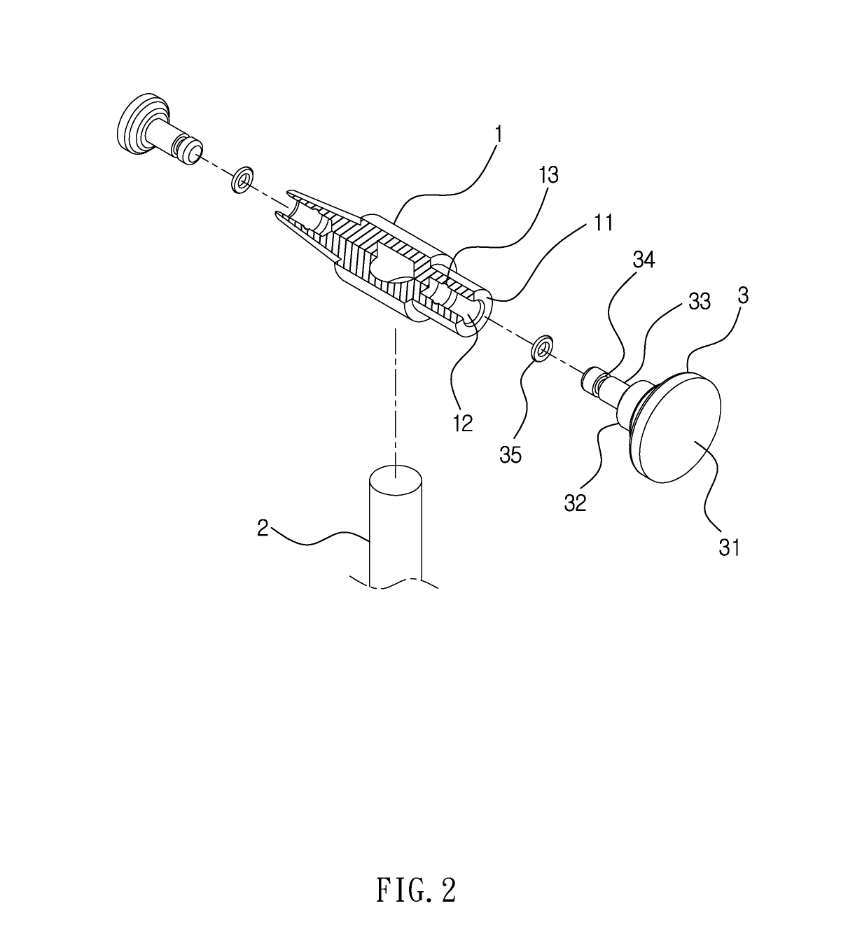

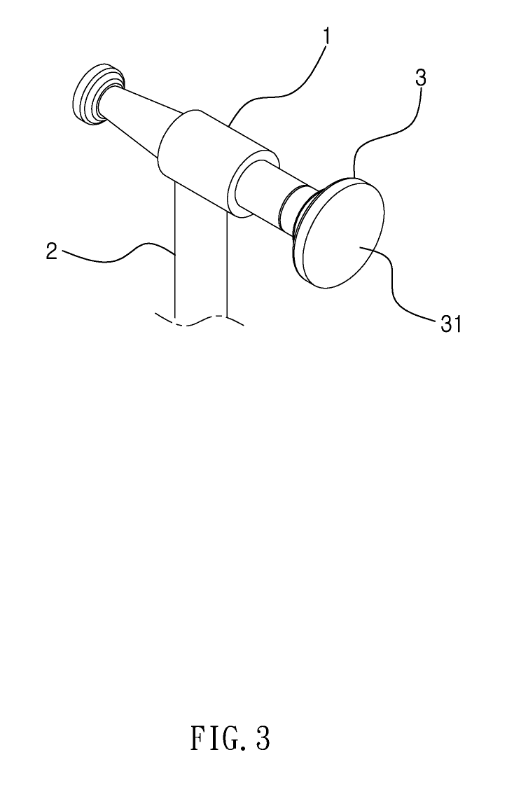

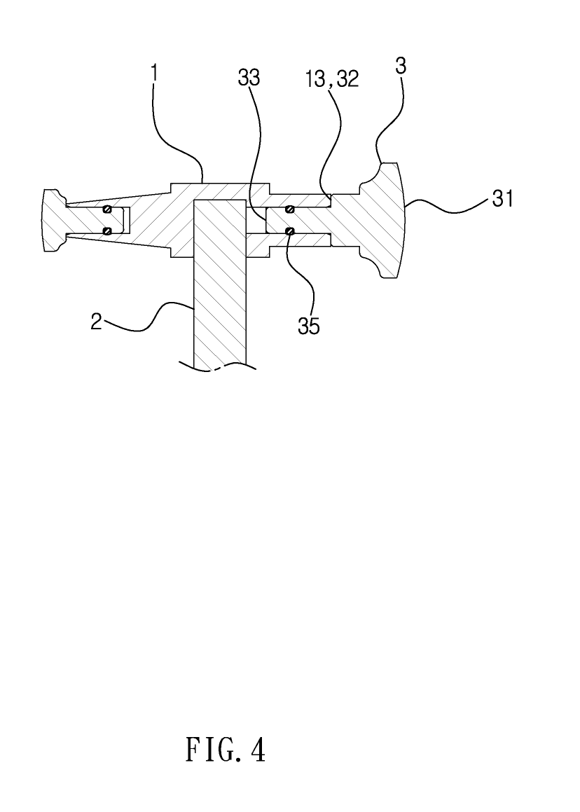

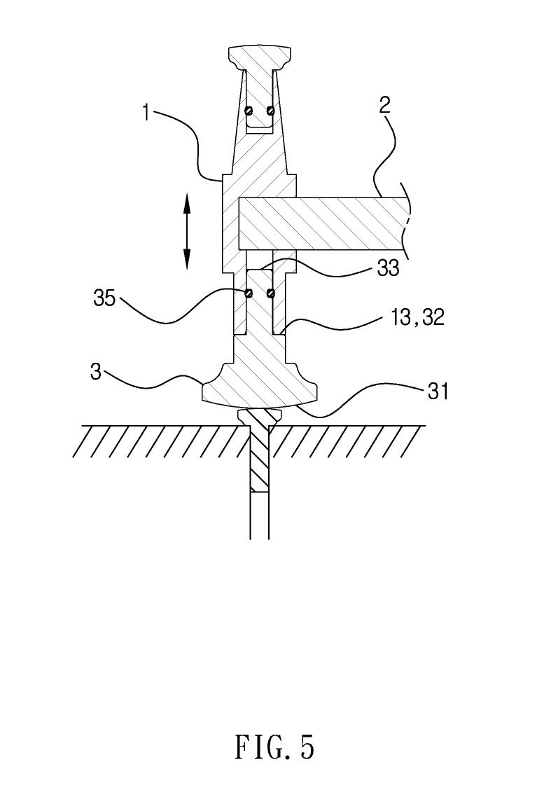

With reference to FIGS. 2 to 6, a replaceable hitting structure for a hammer according to a preferred embodiment of the present invention is capable of prolonging service life of the hammer and comprises: a body 1, a handle 2 extending downwardly from a middle portion of the body 1, and at least one hitting block 3 connected with one side the body 1. In this embodiment, two hitting blocks 3 are connected with the one side of the body 1.

The body 1 includes an accommodation extension 11 arranged on one end thereof, a housing groove 12 defined in the accommodation extension 11, and a peripheral trench 13 defined in the housing groove 12. Each hitting block 3 includes a hammering face 31 formed on a first side thereof, a connecting face 32 arranged on a second side thereof, a coupling post 33 extending outwardly from the connecting face 32 and accommodated in the housing groove 12, a fixing notch 34 defined on an outer wall of the coupling post 33, and a positioning ring 35 retained in the fixing notch 34. When the coupling post 33 is housed in the housing groove 12, the positioning ring 35 contacts with the peripheral trench 13 of the body 1, and the connecting face 32 engages with the accommodation portion 11 matingly, hence said each hitting block 3 is connected with the body 1 quickly and securely.

When the positioning ring 35 contacts with the peripheral trench 13, the connecting face 32 engages with the accommodation portion 11 matingly so that said hitting block 3 absorbs impact force and vibration of the body 1 as hitting an object by using the hammer

The positioning ring 35 is flexible and is made of rubber (such as a C ring).

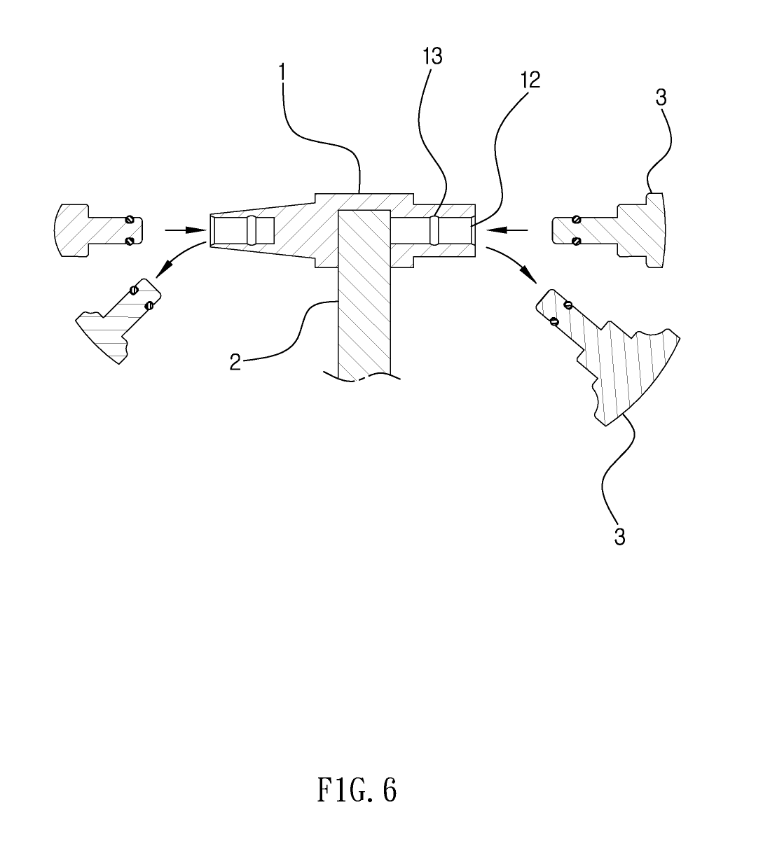

Thereby, the hitting structure of the present invention is capable of replacing hitting blocks 3 of various sizes based on using requirements, as shown in FIG. 6. Preferably, said each hitting block 3 is made of any one of metal, wood and rubber so as to absorb the impact force and the vibration of the body 1 effectively.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A replaceable hitting structure for a hammer comprising:
a body, a handle extending downwardly from a middle portion of the body, and at least one hitting block connected with one side the body;
wherein the body includes an accommodation extension arranged on one end thereof, a housing groove defined in the accommodation extension, and a peripheral trench defined in the housing groove;
wherein each hitting block includes a hammering face formed on a first side thereof, a connecting face arranged on a second side thereof, a coupling post extending outwardly from the connecting face and accommodated in the housing groove, a fixing notch defined on an outer wall of the coupling post, and a positioning ring retained in the fixing notch;
wherein when the coupling post is housed in the housing groove, the positioning ring contacts with the peripheral trench of the body, and the connecting face engages with the accommodation portion matingly, hence said each hitting block is connected with the body quickly and securely.

2. The replaceable hitting structure for a hammer as claimed in claim 1, wherein the positioning ring is a C ring.
